(19) United States
(12) Patent Application Publication
(10) Pub. No.: US 2012/0136842 A1
(43) Pub. Date: May 31, 2012

(54) PARTITIONING METHOD OF DATA BLOCKS

(75) Inventors: Ming-Sheng Zhu, Tianjin (CN); Chih-Feng Chen, Taipei (TW)

(73) Assignee: INVENTEC CORPORATION, Taipei (TW)

(21) Appl. No.: 13/070,052

(22) Filed: Mar. 23, 2011

(30) Foreign Application Priority Data
Nov. 30, 2010 (CN) 201010589567.9

(51) Int. Cl. G06F 17/30

(52) U.S. Cl. 707/692; 707/E17.005

(57) ABSTRACT

A partitioning method of data blocks is applied to a data de-duplication process. The method includes the following steps. A file structural tank partitioning program and a data block partitioning process are performed on an input file. A fingerprint feature value of a generated data block is compared with fingerprint feature values recorded in completed file structural tanks. If a duplicate fingerprint feature value exists in another file structural tank, it is determined whether the duplicate data block is a first data block of the existing file structural tank. If the data block is the same as the first data block of the existing file structural tank, it is further determined whether the structural tank feature values of the file structural tanks of the two data blocks are the same; and if yes, the data block to be compared is deleted.

### CROSS-REFERENCE TO RELATED APPLICATIONS

This non-provisional application claims priority under 35 U.S.C. §119(a) on Patent Application No(s). 201010589567.9 filed in China, P.R.C. on Nov. 30, 2010, the entire contents of which are hereby incorporated by reference.

### FIELD OF THE INVENTION

The present invention relates to a partitioning method of data blocks, and more particularly to a partitioning method of data blocks for a data de-duplication process.

### BACKGROUND OF THE INVENTION

A data de-duplication process is a data reduction technology, generally applied in a disk-based backup system, and the main purpose thereof is to reduce a memory capacity used in a memory system. The operating mode of the data de-duplication process is searching duplicate size-variable data blocks at different positions of different files during a certain time period, and the duplicate data blocks are replaced by indicators. Since the memory system is always populated with a large amount of redundant data, in order to address the problem and save more space, it is natural that the “de-duplication” technology becomes the focus of attention. By adopting the “de-duplication” technology, stored data may be reduced to 1/20 of the original amount, and thus more backup space is saved, such that the backup data in the memory system may be stored for a longer time, and a large amount of bandwidth required during off-line storage is also saved.

In order to determine whether the data blocks in the storage system are duplicated, a fixed-size partition or a content-defined chunking (CDC) is used as a basis of determination in the prior art. After the above partitioning process, each partitioned data block is sequentially stored in a particular file structure, and the file structure is defined as a file structural tank below for clear description. FIG. 1 is a schematic view of a file structure of a data block in the prior art. Referring to FIG. 1, each file structural tank 100 has a capacity of an equal size. It is merely necessary for the data de-duplication process to check whether the data blocks 110 in the same file structural tank 100 are duplicated. The partitioned data blocks 110 and corresponding fingerprint information 120 are sequentially stored in the file structural tanks 100.

Though the storage mode in the prior art is convenient, the same data blocks may exist in different file structural tanks 100 by adopting the storage mode. As a result, the purpose of data de-duplication cannot be effectively achieved.

### SUMMARY OF THE INVENTION

Accordingly, the present invention is a partitioning method of data blocks, applied to a data de-duplication process, so as to divide an input file into a plurality of data blocks.

The partitioning method of data blocks comprises the following steps. A first sliding window is sequentially moved in an input file, so as to generate a file structural tank corresponding to a length of the first sliding window and a structural tank feature value corresponding to the file structural tank. A data block partitioning process is sequentially performed on the input file within a range of the first sliding window by using a second sliding window, so as to generate a data block and a fingerprint feature value of the input file corresponding to the second sliding window. The belonging data block and the fingerprint feature value corresponding to the data block are recorded in each file structural tank. The newly-generated data block is defined as a target data block. The target data block is compared with the existing file structural tanks, to search whether a duplicate fingerprint feature value exists. If a fingerprint feature value duplicated with the target data block exists in the existing file structural tanks, it is determined whether the duplicate fingerprint feature value is a first data block of the belonging file structural tank. If the data block is the first data block of the file structural tank, the file structural tank and the structural tank feature value corresponding to the target data block are calculated, and the structural tank feature values of the data block and the target data block are compared to determine whether the two are the same. If the structural tank feature values of the data block and the target data block are the same, the first sliding window is moved. If the structural tank feature values of the data block and the target data block are different, the target data block is deleted, and the comparison between the data blocks is performed repeatedly until the input file is completed.

In the partitioning method of the data blocks for data de-duplication according to the present invention, the duplicate data is determined according to the data block as well as the file structural tank. Since the file length of the file structural tank is larger than that of the data block, the duplicate data may be obtained faster by comparison, thereby improving the storage capacity.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a file structure of a data block in the prior art;

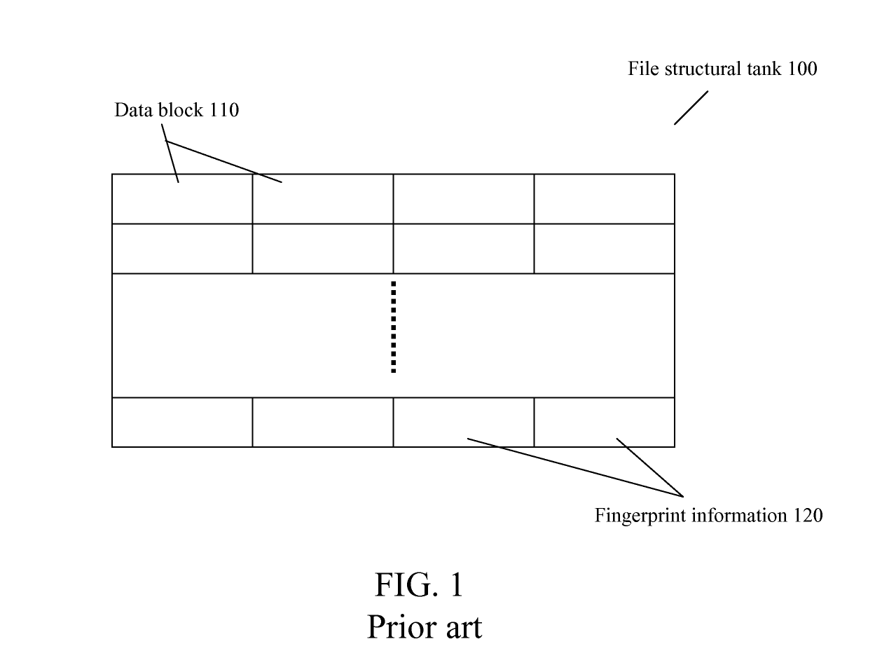

FIG. 2 is a schematic flow chart of a partitioning operation according to the present invention;

FIG. 3 is a schematic view of a first sliding window and a second sliding window according to the present invention;

FIG. 4 is a schematic view of a second sliding window and a data block according to the present invention; and

FIG. 5 is a schematic structural view of a file structural tank according to the present invention.

### DETAILED DESCRIPTION OF THE INVENTION

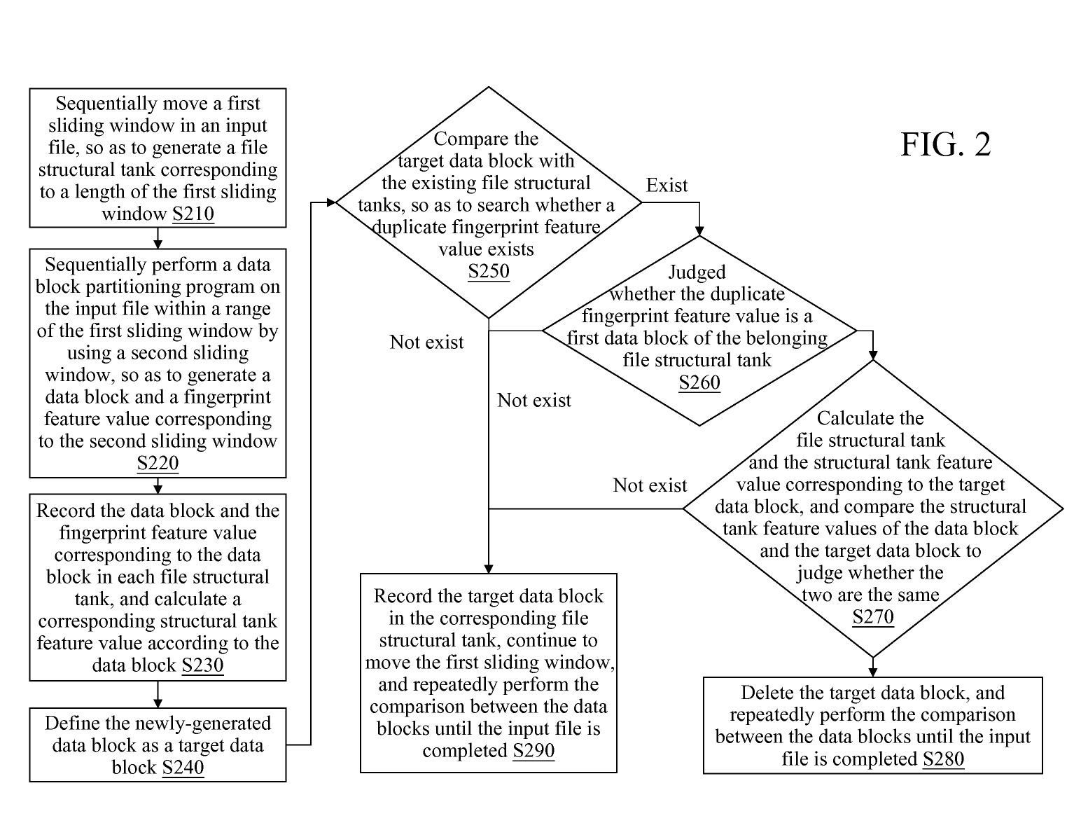

The present invention is applicable to a computer, for example, a personal computer, a notebook computer, or a server, with a program for processing data de-duplication, or applicable to a client and server architecture. In order to make clear an operation flow and an actual dividing mode of data blocks of the present invention, reference is made to FIG. 2, which is a schematic flow chart of a partitioning operation according to the present invention. The present invention comprises the following steps.

In Step S210: a first sliding window is sequentially moved in an input file, so as to generate a file structural tank corresponding to a length of the first sliding window.

In Step S220: a data block partitioning process is sequentially performed on the input file within a range of the first sliding window by using a second sliding window, so as to generate a data block and a fingerprint feature value corresponding to the second sliding window.

In Step S230: the data block and the fingerprint feature value corresponding to the data block are recorded in each file structural tank, and a corresponding structural tank feature value is calculated according to the data block.

In Step S240: the newly-generated data block is defined as a target data block.

In Step S250: the target data block is compared with the existing file structural tanks, so as to search whether a duplicate fingerprint feature value exists.

In Step S260: if a fingerprint feature value duplicated with the target data block exists in the existing file structural tanks, it is judged whether the duplicate fingerprint feature value is a first data block of the belonging file structural tank; and if a fingerprint feature value duplicated with the target data block does not exist in the existing file structural tanks, Step S290 is executed.

In Step S270: if the data block is the first data block of the file structural tank, the file structural tank and the structural tank feature value corresponding to the target data block are calculated, and the structural tank feature values of the data block and the target data block are compared to judge whether the two are the same; and if the data block is not the first data block of the file structural tank, Step S290 is executed.

In Step S280: if the structural tank feature values of the data block and the target data block are the same, the target data block is deleted, and the comparison between the data blocks is performed repeatedly until the input file is completed; and if the structural tank feature values of the data block and the target data block are different, Step S290 is executed.

In Step S290: if the structural tank feature values of the data block and the target data block are different, the target data block is recorded in the corresponding file structural tank, the first sliding window is continuously moved, and the comparison between the data blocks is performed repeatedly until the input file is completed.

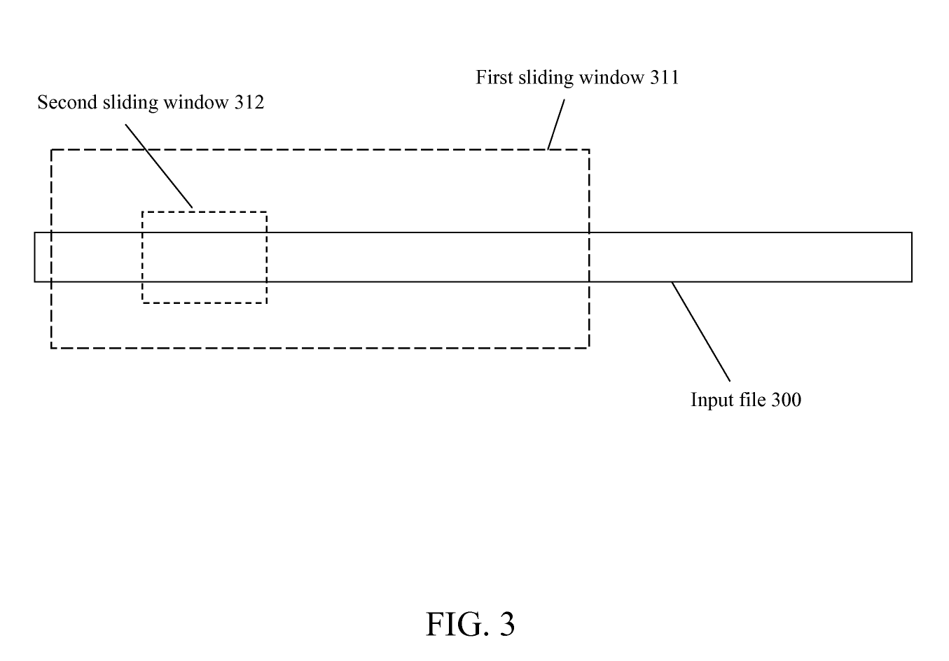

Firstly, an input file 300 is loaded into a computer where a data de-duplication process is run. In the de-duplication process of the present invention, two sliding windows with different lengths are operated. The two sliding windows are respectively defined as a first sliding window 311 and a second sliding window 312 herein, and the length of the first sliding window 311 is smaller than (or equal to) that of the second sliding window 312. The first sliding window 311 and the second sliding window 312 are sequentially moved in the input file 300, and a fingerprint feature value is calculated in a range covered by the sliding windows (a calculation mode thereof will be described later), which is used as a basis of the determination of whether to partition. FIG. 3 is a schematic view of the first sliding window 311 and the second sliding window 312 according to the present invention.

The first sliding window 311 is moved in the input file 300 according to a fixed length in a non-overlapping manner, and a corresponding file structural tank is generated according to a position where the first sliding window 311 is located on the input file 300. Then, a fingerprint feature value is calculated for a part of the input file 300 covered by the file structural tank, and the fingerprint feature value is defined as a structural tank feature value herein.

Subsequently, the second sliding window 312 is moved according to a fixed pitch in a range covered by the first sliding window 311. For example, if a byte is taken as a moving unit each time, the sliding window is sequentially moved in the first sliding window 311 by a byte each time. In other words, an interval between a starting position of the second sliding window 312 for the first time and a starting position of the second sliding window 312 for the second time is one byte. If five bytes are taken as a moving unit, the second sliding window 312 is moved in the first sliding window 311 by an interval of five bytes each time.

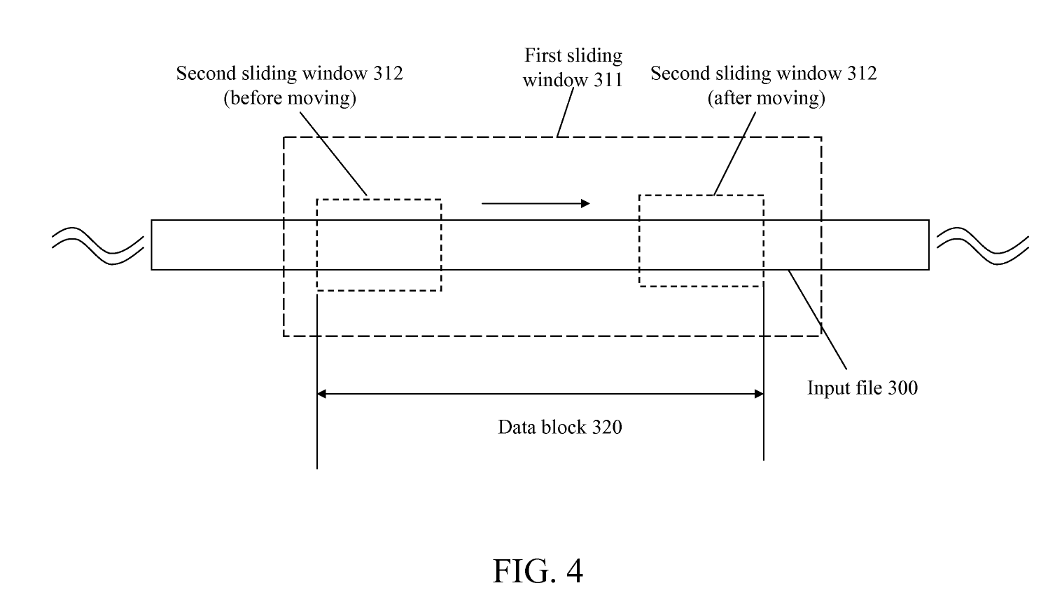

When the second sliding window 312 starts to be moved, the starting position of the second sliding window 312 in the input file 300 is firstly recorded. Then, a corresponding fingerprint feature value is calculated for a part of the input file 300 covered by the second sliding window 312, and it is determined whether the fingerprint feature value is in accordance with a partitioning condition. When the fingerprint feature value is in accordance with the partitioning condition, a length between the starting position and an end position of the second sliding window 312 in the input file 300 is defined as a sub-block length of a data block 320. FIG. 4 is a schematic view of the second sliding window and the data block according to the present invention.

When the fingerprint feature value is not in accordance with the partitioning condition, the second sliding window 312 is continuously moved, until the fingerprint feature value in the covered range is in accordance with the partitioning condition. Therefore, the lengths covered by the second sliding window 312 in the input file 300 are not equal each time, and the lengths of each data block 320 are not necessarily the same.

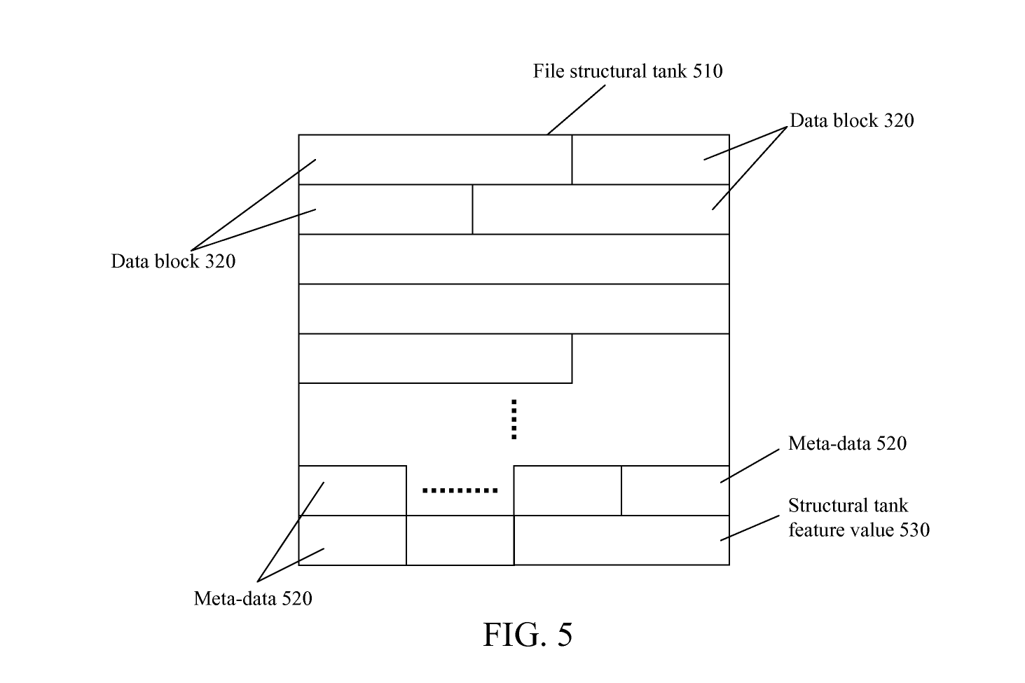

After a data block 320 is generated each time, the data de-duplication process sequentially records the data block 320 and the corresponding fingerprint feature value in the corresponding file structural tank. For example, the data blocks 320 generated in the range of the input file 300 covered by the first file structural tank are recorded in the file structural tank one by one according to their generation sequence. Therefore, each file structural tank 510 keeps a record of several data blocks 320, meta-data, and structural tank feature values 530. FIG. 5 is a schematic structural view of a file structural tank according to the present invention. Different meta-data 520 is used to record the fingerprint feature value of the corresponding data block 320. Therefore, when the file is read, the system firstly reads the file that has been data de-duplicated. Then, a corresponding data block is taken out from the memory system according to a sequence of the meta-data 520, and is recovered to the input file 300.

When a new data block 320 is generated each time in the present invention, not only whether a duplicate data block 320 exists before is determined by comparison, but also whether the structural tank feature values 530 are duplicated is determined by comparison at the same time. In order to make clear the comparison objects of different data blocks 320, the newly-generated data block 320 is defined as a target data block (not shown), and the other data blocks 320 are referred to as existing data blocks (not shown).

When the target data block is generated, the target data block is compared with the data block 320 in the existing file structural tanks 510, so as to determine whether a duplicate fingerprint feature value exists. If no duplicate fingerprint feature value is found in the existing file structural tanks 510, the target data block is recorded in a corresponding file structure. If a fingerprint feature value duplicated with the target data block exists in the existing file structural tanks 510, it is determined whether the found duplicate fingerprint feature value is a first data block 320 of the belonging file structural tank 510.

If the data block 320 is not the first data block 320 of the belonging file structural tank 510, the target data block is directly deleted, and a record of corresponding data de-duplication is performed. If the data block 320 is the first data block 320 of the belonging file structural tank 510, the file structural tank 510 and the structural tank feature value 530 corresponding to the target data block are calculated. Then, the structural tank feature value 530 of the data block 320 is compared with that of the target data block to determine whether the two are the same. In other words, the belonging structural tank feature values 530 of the two data blocks 320 are compared to determine whether the two are the same.

If the two structural tank feature values 530 are the same, it indicates that the existing data block after the target data block is also duplicated. Therefore, in the present invention, the subsequent existing data block after the target data block is not calculated, and instead, the subsequent existing data block is recorded as duplicate data of the target data block according to the existing file structural tank 510. Since a plurality of identical file structural tanks 510 may appear in the same input file 300, although the data de-duplication effect may be achieved through one-by-one comparison between the data blocks 320, more time is required if all the data blocks 320 are compared.

If the two structural tank feature values 530 are different, it indicates that the subsequent data block 320 after the target data block is different from the existing file structural tanks 510. Thus, the data de-duplication process is merely performed on the target data block.

After the processing of the target data block is finished, the data de-duplication process determines whether the trailer of the input file 300 is reached, and if yes, the data de-duplication process for the file is finished; otherwise, the generation and determination of the data block 320 are continuously performed.

In the partitioning method of the data blocks 320 for data de-duplication according to the present invention, the duplicate data is determined according to the data block as well as the file structural tank 510. Since the file length of the file structural tank 510 is larger than that of the data block, the duplicate data may be obtained faster by comparison, thereby improving the storage capacity.

What is claimed is:

1. A partitioning method of data blocks, applied to a data de-duplication process, for dividing an input file into a plurality of data blocks, the method comprising:
sequentially moving a first sliding window in the input file, so as to generate a file structural tank corresponding to a length of the first sliding window;
sequentially performing a data block partitioning process on the input file within a range of the first sliding window by using a second sliding window, so as to generate a data block and a corresponding fingerprint feature value;
recording the belonging data block and the fingerprint feature value corresponding to the data block in each file structural tank, and calculating a corresponding structural tank feature value according to the data block;
defining the newly-generated data block as a target data block, and comparing the target data block with the existing file structural tanks, to search whether a duplicate fingerprint feature value exists;
if the fingerprint feature value duplicated with the target data block exists in the existing file structural tanks, judging whether the duplicate fingerprint feature value is a first data block of the belonging file structural tank;
if the data block is the first data block of the file structural tank, calculating the file structural tank and the structural tank feature value corresponding to the target data block, and comparing the structural tank feature values of the data block and the target data block, to judging whether the two are the same;
if the structural tank feature values of the data block and the target data block are the same, moving the first sliding window; and
if the structural tank feature values of the data block and the target data block are different, deleting the target data block, and repeatedly performing the comparison between the data blocks until the input file is completed.

2. The partitioning method of data blocks according to claim 1, wherein the first sliding window is moved in the input file in a non-overlapping manner.

3. The partitioning method of data blocks according to claim 1, wherein if no fingerprint feature value duplicated with the target data block exists in the existing file structural tanks, the target data block is deleted, and the comparison between the data blocks is performed repeatedly.

4. The partitioning method of data blocks according to claim 1, wherein if the data block is not the first data block of the file structural tank, the target data block is deleted, and the comparison between the data blocks is performed repeatedly.

5. The partitioning method of data blocks according to claim 1, wherein the file structural tank further comprises meta-data, for recording position information of the corresponding data block in the input file.
